(19) United States
(12) Patent Application Publication
(10) Pub. No.: US 2026/0119374 A1
(43) Pub. Date: Apr. 30, 2026

(54) METHOD AND SYSTEM FOR GENERATING TEST SCRIPTS FOR A STREAMING APPLICATION

(71) Applicant: LTI Mindtree Ltd, Mumbai (IN)

(72) Inventor: Shankaranarayanan Ganapathiraman, Mumbai (IN)

(21) Appl. No.: 19/068,155

(22) Filed: Mar. 3, 2025

(30) Foreign Application Priority Data
Oct. 31, 2024 (IN) 202421083570

(51) Int. Cl. G06F 11/3668

(52) U.S. Cl. CPC G06F 11/3684; G06F 11/3688

(57) ABSTRACT

A method and system for generating test cases for a streaming application is disclosed. An execution plan for testing a functionality of the streaming application is received. A machine-learning module determines a workflow data associated with the functionality using at least one of a user profile library, an intent library, a device library, an input devices library, and a navigation library. A first and a second portion of the workflow are categorized into converging patterns and diverging patterns based on consistencies and variations in the workflow respectively. A test components generation module generates a first set and a second set of test components from the converging and the diverging patterns. A unique test cases corresponding to each of the plurality of platforms, operating systems, end devices, user profiles, and versions of the streaming application is then generated at runtime.

### FIELD

Various embodiments of the present disclosure relate generally to the field of software testing, and more specifically, to methods and systems for generating test scripts for streaming applications, particularly those involving complex workflows across multiple platforms, user profiles and environments.

### BACKGROUND

Test automation has seen significant evolution through a range of methodologies and technologies, including data-driven, keyword-driven, behavior-driven development (BDD), test-driven development (TDD), acceptance test-driven development (ATDD), continuous delivery/continuous testing (CD/CT), and unified multi-channel approaches.

In recent years, the integration of Artificial Intelligence (AI) and Machine Learning (ML) capabilities has further advanced the field. Despite the availability of various AI/ML-based solutions, such as Mabl, Tricentis, and Cosmos QE platform, adoption rates remained relatively low. A notable gap in these solutions is their lack of independence from specific applications, user profiles or platforms, which limits their versatility and broader application.

Currently, test automation scripts are created and maintained separately for each platform, device, and streaming application. This approach results in a significant amount of duplicated code repositories, which requires substantial engineering effort for script development and maintenance across various apps and platform combinations. The proliferation of these repositories, often numbering in the tens or hundreds, leads to considerable wasted effort, even when using AI-based generation models that produce scripts separately for each app and platform.

Additionally, managing these numerous code repositories incurs substantial cloud storage costs. The current execution models are primarily focused on user actions, which limits their capability to adapt to new-age, intent-based interfaces and emerging solutions. Furthermore, existing models often lack customization for specific domain needs, such as streaming apps and dynamic quality engineering (QE) execution plans based on predictive analytics.

Moreover, the current execution models primarily concentrate on simulating user actions, which limit their adaptability to modern, intent-based interfaces that are becoming more prevalent. The new-age interfaces are designed to interpret and respond to user intent rather than following the traditional, action-oriented approach. As a result, traditional models are increasingly inefficient and incompatible for effectively testing these modern, intent-driven systems.

In addition, existing automation models frequently lack the necessary customization to address specific domain needs, such as those related to streaming applications or dynamic quality engineering (QE) execution plans. For instance, streaming applications often require specialized testing approaches that account for real-time data processing and playback, while dynamic QE execution plans rely on predictive analytics to optimize test strategies. The inability of current models to cater to these specialized needs hampers their effectiveness and relevance.

Therefore, there exists a need for a mechanism that can create test scripts that are adaptive and agnostic to any platform, device, application, and user profile, resulting in elimination of 100s of duplicated repositories and thereby significantly reducing code footprint, and improving maintainability of automation scripts and frameworks.

### SUMMARY

The present disclosure discloses a method and system for generating test scripts for a streaming application. A planning module receives a test execution plan for testing one or more functionalities of the streaming application based on a set of parameters such as, intent, environment, test data, and user profiles. A trained machine-learning model determines a workflow data associated with the one or more functionalities of the streaming application with respect to each of a plurality of platforms, each of a plurality of operating systems, each of a plurality of end devices, each of a plurality of user profiles, and each of a plurality of versions of the streaming application. The workflow is determined using at least one of a user profile library, an intent library, a device library, an input library, and a navigation library.

A first portion of the workflow and a second portion of the workflow are categorized into converging patterns and divergent patterns. A workflow that is consistent across the plurality of platforms, the plurality of operating systems, the plurality of end devices, each of the plurality of user profiles, and the plurality of versions of the streaming application is categorized as converging patterns and a workflow that varies across the plurality of platforms, the plurality of operating systems, the plurality of end devices, and the plurality of versions of the streaming application is categorized as diverging patterns.

A trained machine-learning model generates a first set of test components corresponding to the converging patterns and a second set of test components corresponding to the diverging patterns. A unique test script corresponding to each of the plurality of platforms, each of the plurality of operating systems, each of the plurality of end devices, each of the pluralities of user profiles, and each of the plurality of versions of the streaming application is generated by stitching one or more test components from the first set of test components and the second set of test components.

One or more advantages of the prior art are overcome, and additional advantages are provided through the disclosure. Additional features are realized through the technique of the disclosure. Other embodiments and aspects of the disclosure are described in detail herein and are considered a part of the disclosure.

### BRIEF DESCRIPTION OF THE FIGURES

FIG. 1 is a diagram that illustrates an exemplary environment within which various embodiments of the present disclosure may function.

FIG. 2 is a diagram that illustrates a test automation system for generating test scripts for a streaming application, in accordance with an embodiment of the disclosure.

FIG. 3 is a flow chart with a method for generating test scripts for a streaming application, in accordance with an embodiment of the present disclosure.

### DETAILED DESCRIPTION

In one general aspects of this disclosure, a system of one or more computer executable software and data, computer machines and components thereof, networks, and/or network equipment can be configured to perform particular operations or actions individually, collectively, or in a distributed manner to cause the system of components thereof to determine convergence and divergence patterns and generate test cases agnostic of platforms, devices, streaming applications, and user profiles.

In some non-limiting embodiments, the present disclosure provides a method and system for generating test scripts applicable to a wide range of application domains such as, but not limited to, travel, healthcare, insurance, and retail, with adjustments to the model's training to tailor it for the specific requirements of each domain's application usage.

Various embodiments of the present disclosure disclose a method and system for generating test scripts for a streaming application. A planning module receives a test execution plan for testing one or more functionalities of the streaming application based on a set of parameters such as, intent, environment, test data, and user profiles. A trained machine-learning model determines the workflow data associated with the one or more functionalities of the streaming application with respect to each of a plurality of platforms, each of a plurality of operating systems, each of a plurality of end devices, each of a plurality of user profiles, and each of a plurality of versions of the streaming application. The trained machine-learning model determines the workflow using at least one of a user profile library, an intent library, a device library, an input library, and a navigation library.

A first portion of the workflow and a second portion of the workflow are categorized into converging patterns and diverging patterns respectively. A workflow that is consistent across the plurality of platforms, the plurality of operating systems, the plurality of end devices, the plurality of user profiles, and the plurality of versions of the streaming application is categorized as converging patterns. Whereas, a workflow that varies across the plurality of platforms, the plurality of operating systems, the plurality of end devices, the plurality of user profiles, and the plurality of versions of the streaming application is categorized as diverging patterns.

A trained machine-learning model generates a first set of test components corresponding to the converging patterns and a second set of test components corresponding to the diverging patterns. A unique test script corresponding to each of the plurality of platforms, each of the plurality of operating systems, each of the plurality of end devices, each of the user profiles, and each of the plurality of versions of the streaming application is generated by stitching one or more test components from the first set of test components and the second set of test components.

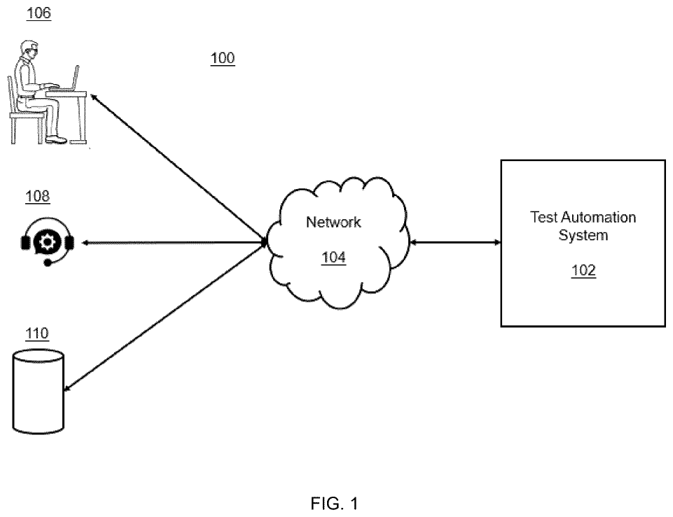

FIG. 1 is a diagram that illustrates an exemplary environment 100 within which various embodiments of the present disclosure may function. Referring to FIG. 1, the environment 100 comprises a test automation system 102, a network 104, a user device 106, a virtual assistant 108, and a knowledgebase 110.

As shown in FIG. 1, the test automation system 102 of the present disclosure dynamically generates test scripts based on the workflow data associated with the functionality of the streaming application. The test automation system 102 leverages real-time data and contextual information to generate test scripts that precisely reflect the current state and requirements of the streaming application under test.

In one or more embodiments, the test scripts generated by the test automation system 102 are adaptive and work agnostically across the plurality of platforms, the plurality of operating systems, the plurality of end devices, the plurality of user profiles, and the plurality of versions of the streaming application.

In one or more embodiments, the test automation system 102 leverages Generative Artificial Intelligence (GenAI) to determine the workflow data which defines user interactions from a start point and an end point with respect to access and usage of one or more functionalities of the streaming application. The GenAI may determine the workflow data by leveraging data from at least one of a group of libraries such as, a user profile library, an intent library, a device library, and a navigation library.

In an exemplary embodiment, the GenAI may include models such as, but not limited to, predictive analytics models, natural language generation models, behavioral pattern recognition systems, Generative Adversarial Networks (GANs), Variational Autoencoders (VAEs), and intent recognition models.

The test automation system 102, upon determining the workflow data, using the GenAI corresponding to the functionality of the streaming application across the plurality of platforms, the plurality of operating systems, the plurality of end devices, the plurality of user profiles, and the plurality of versions of the streaming application identifies consistent patterns in the workflow data across the plurality of platforms, the plurality of operating systems, the plurality of end devices, the plurality of user profiles, and the plurality of versions of the streaming application and categorizes the same as convergence patterns and identifies variations in the workflow data and categorizes the same as divergent patterns.

In one or more embodiments, the convergence patterns refer to consistencies in the workflow data across the plurality of platforms, the plurality of operating systems, the plurality of end devices, the plurality of user profiles, and the plurality of versions of the streaming application. For example, the convergence patterns indicate common ways of a user interacting with a particular functionality of the streaming application in different environments.

In some embodiments, the divergent patterns refer to variations in the workflow data across the plurality of platforms, the plurality of operating systems, the plurality of end devices, the plurality of user profiles, and the plurality of versions of the streaming application. For example, the divergent patterns indicate different ways of a user interacting with a particular functionality of the streaming application in different environments.

In one or more embodiments, a plurality of test components corresponding to the convergence patterns and divergence patterns are generated, and a unique test script corresponding to each of the plurality of platforms, each of the plurality of operating systems, each of the plurality of end devices, each of the plurality of user profiles, and each of the plurality of versions of the streaming application is stitched, at runtime, using the one or more of the plurality of test components.

In some embodiments, the network 104 includes communication networks operable to facilitate communication, either wirelessly or wired. The network 104 connects a plurality of computer systems. The network 104 may comprise, for example, an intranet, local area network, wide area network, the internet, public switched telephone network (PSTN), network of networks, or other network.

In one or more embodiments, the network 104 facilitates connection between the test automation system 102 and the user 106, the virtual assistant 108, and the knowledgebase 110.

In an exemplary embodiment, the user device 106 may include a smartphone or a tablet computer. In other examples, the user device 106 may include a laptop computer, a desktop computer, and/or another type of computing device. The user device 106 may be used for inputting, processing, and displaying information.

The virtual assistant 108 may be a chatbot capable of communicating with the user device 106. For example, the virtual assistant 108 may conduct a chat with the user device 106 in which virtual assistant 108 offers to walk the user through a particular sequence of steps via the user interface.

The number and arrangement of components shown in FIG. 1 are provided as an example. In practice, the system may include additional components, fewer components, different components, or differently arranged components than those shown in FIG. 1. Additionally, or alternatively, a set of components (e.g., one or more components) of the system may perform one or more functions described as being performed by another set of components of the environment 100.

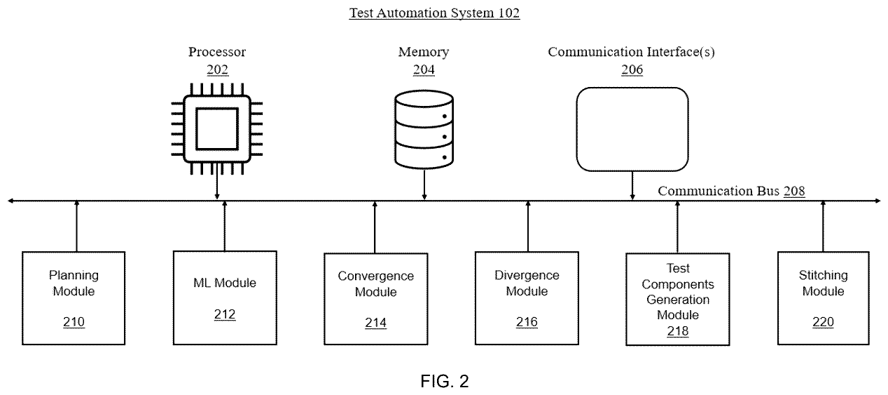

FIG. 2 is a diagram that illustrates a test automation system 102 for generating test scripts, in accordance with an embodiment of the disclosure.

Referring to FIG. 2, the test automation system 102 comprises a processor 202, a memory 204, a communication interface 206, a communication bus 208, a planning module 210, a Machine Learning module 212, a convergence module 214, a divergence module 216, a test components generation module 218, and a stitching module 220.

The processor 202 may comprise suitable logic, interfaces, and/or code that may be configured to execute the instructions stored in the memory 204 to implement various functionalities of the test automation system 102 in accordance with various aspects of the present disclosure. The processor 202 may be further configured to communicate with various modules of the test automation system 102 via the communication bus 208.

The memory 204 may comprise suitable logic, and/or interfaces, that may be configured to store instructions (for example, computer-readable program code) that can implement various aspects of the present disclosure.

The communication interface(s) 206 may include one or more interfaces to enable the test automation system 102 to access a computer network such as a Location Area Network (LAN), a Wide Area Network (WAN), a Personal Area Network (PAN), or the internet through a variety of wired and/or wireless connections, including cellular connections.

The communication bus 208 is configured to serve the test automation system 102, facilitating seamless communication, integration, and coordination among its constituent components. Through its role as a centralized message broker, the communication bus 208 enables automatically generating test cases that are agnostic of various platforms, various operating systems, various end devices, various user profiles, and various version of streaming application.

The planning module 210 may comprise suitable logic, and/or interfaces, that may be configured to receive an execution plan for executing one or more test scripts to test one or more functionalities of the streaming application.

In one or more embodiments, the execution plan is defined based on one or more parameters such as, but not limited to, intents of a quality engineer (QE), environment of testing, test data, and profile of a user. The intents of QE for testing can be such as, for instance, what portion of the workflow to be tested, where to be tested, which platform to be tested, which suites to be tested.

In accordance with the one or more embodiments, a portion of the workflow to be tested may involve determining which parts of the application workflow data, spanning from a start point to an end point of user interactions with one or more elements of the streaming application require testing. The location of testing may specify where the tests should be executed, such as in a staging environment, a production-like environment, or a local development setup. The platform to be tested may involve identifying the platforms on which the tests should be executed, including, but not limited to different operating systems, different end devices, and different browsers.

In an exemplary embodiment, the portion of the workflow to be tested may comprise identifying and specifying segments of the streaming application's workflow that require evaluation. This process may include determining which specific stages, actions, or interactions from the initial user input to the final output are critical to test. The streaming application may involve user interactions with dynamic elements, such as video playback, content navigation, or real-time data updates. Accordingly, it may be necessary to establish a detailed workflow map using a navigation engine that represents all potential user journeys, including starting points and endpoints. The navigation engine may interact with various user interface (UI) elements at each step of the journey, facilitating the identification of key inputs (e.g., triggering actions such as clicks or taps) and outputs (e.g., assertions for validation) across diverse platforms, devices, user profiles, and input methods. This approach may ensure comprehensive testing coverage, thereby enhancing the reliability and accuracy of the streaming application.

In an exemplary embodiment, the staging environment can include a pre-production environment that closely mirrors the production setup. Testing in this environment helps ensure that the application behaves as expected under conditions similar to those in the live environment. Production-like environment refers to an environment that replicates the production environment but may not be a full-scale deployment. It allows for testing in conditions that approximate the live setting. And the local development setup includes an individual developer's or tester's local machine or private test environment where preliminary or smaller-scale tests are conducted.

In an exemplary embodiment, the platform to be tested may include various operating systems such as Windows™, macOS™, Linux™, mobile operating systems such as iOS™ and Android™, as well as TV operating systems such as Samsung's Tizen™, LG's webOS™, and Roku OS™. Testing across different operating systems may ensure compatibility and performance consistency. Different end devices, such as desktop computers, laptops, tablets, smartphones and smart TVs, may have varying hardware specifications and screen sizes that could affect application behavior. Different web browsers, such as Google Chrome™, Mozilla Firefox™, and Microsoft Edge™ may render web content differently, making it essential to conduct testing across multiple browsers is to ensure uniform user experience and consistent functionality.

In another exemplary embodiment, the platform to be tested may also include API and microservice layers. Testing the API layer may involve validating the functionality, reliability, performance, and security of API endpoints, ensuring they handle a variety of input parameters, data formats, and request-response cycles under different network conditions. For instance, the APIs can be such as, RESTful APIs, GraphQL endpoints, and other service protocols. Further, microservice layer testing may include ensuring that individual microservices function correctly. This may involve validating service-to-service communication, load handling, and error recovery mechanisms across microservices.

In accordance with the one or more embodiments, the environment of testing refers to configuration details about the setup and configuration of the testing environment, including hardware specifications, software versions, network settings, and any dependencies.

In accordance with the one or more embodiments, the test data refers to identifying sources from which test data is derived, such as databases, APIs, or generated data. Ensuring the test data covers a range of scenarios, including edge cases, valid inputs, and invalid inputs. Strategies for managing and maintaining test data, including data creation, sanitization, and archival.

In accordance with the one or more embodiments, the user profile may include defining different user roles and their permissions, which affect the types of tests to be executed. These user roles could encompass a wide range of profiles, such as adults, children, and other categories based on demographics or usage patterns. Understanding typical user behaviors and interactions to create realistic test scenarios. Considering any personalization or customization that might affect how the application or system is used by different users.

In an exemplary embodiment, while the planning module 210 receives the execution plan, the machine-learning module 212 is configured to determine the workflow data associated with a functionality of the streaming application with respect to each of the plurality of platforms, each of the plurality of operating systems, each of the plurality of end devices, each of the plurality of user profiles, and each of the plurality of versions of the streaming application. This workflow data encompasses a record of user interactions from the initiation to the completion of specific tasks within the application, capturing how users navigate through different features and functionalities, such as access, utilization, and engagement with various elements. The machine-learning module 212 determines the workflow data by leveraging a comprehensive set of libraries, including the user profile library, the intent library, the device library, and critically, the navigation library.

The navigation engine plays a pivotal role in this process by mapping the user's journey from the start to the endpoint within the application. This journey involves a series of interactions with various UI elements, where the user performs input actions, such as clicks or touches, and receives output responses, such as visual feedback or state changes.

The initiation of the workflow begins when a user takes an initial action, such as opening the application or logging in, with specific details like device type, time, and user identity recorded. Subsequent user actions could include searching for content, browsing categories, selecting a stream, or adjusting settings, leading up to the completion of the workflow, marked by activities such as closing the application, completing a stream, or exiting a feature.

The navigation engine organizes and interprets these interactions, ensuring that the workflow data reflects the precise sequence of user actions and corresponding outputs across diverse environments. This mapping allows the system to accurately assess and generate the necessary test scripts tailored to specific devices and platforms, ensuring that all possible variations in user interaction, input, output, and element behavior are thoroughly covered.

In one or more embodiments, the machine-learning module 212 is trained using a diverse set of parameters, each designed to enhance its ability to simulate real-world conditions and outcomes. These parameters include, but are not limited to, historical data from previous test executions, which allows the model to recognize and adapt to recurring patterns; detailed user interaction data, providing insights into how users engage with the streaming application and how these interactions, including specific inputs and outputs, may affect performance; platform configuration data, capturing the nuances of different environments and setups; and device-specific behavior data, which helps the system account for the unique characteristics and functionalities of individual devices. The navigation engine, in conjunction with these libraries, ensures that the machine-learning module can dynamically adjust to various scenarios, making the testing process both comprehensive and precise by taking into account the user's journey through diverse elements, inputs, and outputs.

In one or more embodiments, the training of the machine-learning module 212 may involve a combination of one or more machine learning models and techniques. The combination of one or more machine learning models and techniques may adaptively enhance ability of the machine-learning module 212, thereby allowing for flexible model adaptation. During this process, the machine-learning module 212 is trained by leveraging both structured and unstructured data as needed for adaptable learning, which allows the machine learning module 212 to dynamically identify and adapt to patterns within the data.

In one or more embodiments, the machine-learning module 212 undergoes a continuous refinement process by incorporating real-time data gathered from ongoing test executions. The dynamic updating mechanism ensures that the machine-learning module 212 remains responsive to the latest trends and changes in the testing environment. As new data is collected from these real-time test executions, the machine-learning module 212 integrates this information to adjust its parameters and enhance its predictive accuracy. This iterative process allows the machine-learning module 212 to fine-tune its understanding of current conditions, user behaviors, and system responses, which in turn leads to the improvement of test scripts.

In an exemplary embodiment, the user profile may include defining different user roles and their permissions, which may affect the types of tests to be executed. These user roles could encompass a wide range of profiles, such as adults, children, and other categories based on demographics or usage patterns. Understanding typical user behaviors and interactions for each profile is crucial to creating realistic test scenarios. Additionally, any personalization or customization that might influence how the application or system is used by different users may also be considered. The user helps the machine-learning module 212 in understanding how different users might interact with the streaming application and determining which aspects of the workflow are crucial to test. By analyzing these profiles, the module can tailor the testing process to accommodate varying user interactions, ensuring that the application performs robustly across all user segments.

In an exemplary embodiment, the intent library includes a collection of predefined intents or goals that quality engineers (QEs) might have, when testing the application. The intent library helps in aligning the test scenarios with specific testing objectives, such as verifying particular features or user interactions.

In an exemplary embodiment, the device library is a repository of information about various end devices, including their specifications, screen resolutions, and hardware capabilities. The device library helps the machine-learning module 212 account for how the application performs across different device types.

In an exemplary embodiment, the devices library provides details on a range of input devices, including keyboards, mice, touchscreens, and styluses, as well as specifications for various end devices, such as screen sizes, processing power, and operating system versions. This devices library helps the machine-learning module 212 understand how different input methods and device characteristics affect user interactions with the application, including device-specific limitations or capabilities.

In an exemplary embodiment, the navigation library comprises a set of predefined paths that illustrate typical user journeys through the application, including various navigation workflows and paths. The navigation library serves a crucial role by assisting the machine-learning module 212 in analyzing common user navigation patterns and pinpointing critical workflows for testing. To maintain its relevance and accuracy, the navigation library is dynamically updated based on real-time user behavior data, ensuring it reflects the latest user interactions. Additionally, the navigation library is interconnected with other essential libraries, such as the page object model (POM) library, trigger library, and assertion library. These connections enable the navigation library to support comprehensive testing and analysis by facilitating detailed script generation and execution across different user scenarios, thereby enhancing the robustness and accuracy of the testing framework.

The convergence module 214 of the test automation system 102 may comprise suitable logic, interfaces, and/or code that may be configured to categorize a first portion of the workflow data that is consistent across the plurality of platforms, the plurality of operating systems, the plurality of end devices, the plurality of user profiles, and the plurality of versions of the streaming application, as convergence patterns.

In one or more embodiments, the workflow data that is consistent refers to a record of user interactions and processes that are common from the initiation to the completion of a specific task with the streaming application. The workflow data captures how the user navigates through various features and functionalities in common patterns, including access, utilization, and engaging with different elements of the streaming application.

Consider an exemplary scenario where a streaming application that supports multiple user profiles needs to be tested across multiple platforms (Windows, macOS, Android, IOS) and various end devices (smartphones, tablets, desktops) with different versions (1.0, 2.0, 3.0). In accordance with various embodiments of the present disclosure, before initiating the testing, the workflow data is collected, including user interactions, timestamps, system responses, and feature engagement.

Thereafter, the convergence module 214 processes the workflow data to identify and analyze patterns that are consistent across the various testing dimensions. For example, the convergence module 214 may observe that navigating to and playing a video follows an identical workflow pattern across different user profiles, devices, and operating systems. This identification of uniformity allows for categorization of such workflow patterns as convergent patterns.

In another scenario, the convergence module 214 identifies that all user profiles, regardless of the device or version, consistently encounter a common process flow for initiating a live stream. This process involves accessing the live stream section, selecting a stream, and interacting with the chat feature. The convergence module 214 captures this as a workflow pattern that remains constant across different environments.

The divergence module 216 of the test automation system 102 may comprise suitable logic, interfaces, and/or code that may be configured to categorize a second portion of the workflow data that varies across the plurality of platforms, the plurality of operating systems, the plurality of end devices, the plurality of user profiles, and the plurality of versions of the streaming application, as divergent patterns.

In one or more embodiments, the variations in the workflow data refers to a record of user interactions and processes that are different from the initiation to the completion of a specific task with the streaming application. The workflow data captures how the user navigates through various features and functionalities in varying patterns, including access, utilization, and engaging with different elements of the streaming application.

Consider an exemplary scenario, where a streaming application that supports multiple user profiles needs to be tested across multiple platforms (Windows, macOS, Android, IOS), various end devices (smartphones, tablets, desktops), and different versions (1.0, 2.0, 3.0). The workflow data is collected, including user interactions, timestamps, system responses, and feature engagement.

By analyzing the workflow data, the divergence module 216 identifies sequences of user interactions that differ based on the operating system, device type, or platform. For example, the divergence module might identify that the process for uploading content is different on iOS devices compared to Android devices, due to varying interface layouts or system permissions. This identification of divergent patterns is then categorized by the divergence module 216 as divergent pattern.

In another exemplary scenario, the divergence module 216 observes that the process of configuring settings within the streaming application varies significantly between desktop and mobile platforms. On desktops, users may access settings through dropdown menus, whereas on mobile devices, settings are often adjusted via a dedicated settings tab accessible through swiping gestures. This differentiation in user interaction demonstrates how workflow patterns adapt based on the device form factor, and these variations are categorized as divergent pattern by the divergence module 216.

Furthermore, the divergence module 216 might identify that the procedure for user authentication exhibits variations across different versions of the application. For instance, older versions might only support password-based authentication, while newer versions introduce biometric options such as fingerprint or facial recognition. This variance in authentication methods is captured and labeled as divergent pattern.

Additionally, the divergence module 216 could pinpoint differences in how users interact with the application's live streaming feature across various user profiles. Regular users might have the option to access enhanced interactive features like instant replays or multiple camera angles, unlike new users who see a more streamlined version of the same feature. These profile-based differences in feature accessibility and interaction are recognized as divergent patterns.

The test components generation module 218 of the test automation system 102 may comprise suitable logic, and/or interfaces, that may be configured to generate a first set of test components corresponding to the converging patterns, and a second set of test components corresponding to the diverging patterns. These components might be partial or complete sets of test instructions tailored to address the specific behaviors observed in those patterns.

In one or more embodiments, the first set of test components refer to individual pieces or units of tests used to assess various aspects of an application's functionality. They may include test scripts, test cases, or other testing artifacts. The first set of test components consists of test cases tailored to test the converging patterns in the workflow.

Test scripts in this set execute predefined sequences of actions that replicate common workflows observed, while test cases evaluate specific aspects of the application's functionality, ensuring that common processes are executed correctly across various environments. Testing artifacts might include data sets that simulate typical user interactions or configurations that replicate common usage scenarios, enhancing the reliability and effectiveness of the tests.

In one or more embodiments, the second set of test components refer to individual pieces or test units of tests used to assess various aspects of an application's functionality. They include test scripts, test cases, or other testing artifacts. The second set of test components consists of test cases tailored to test the divergent patterns in the workflow.

In some non-limiting embodiments, the test automation system 102 may leverage a machine learning model to automate the process of creating the first set and the second set of test components. By using the machine learning model, the test automation system 102 can dynamically and intelligently produce these test components, potentially improving the efficiency and effectiveness of the testing process by adapting to new data, identifying patterns, and refining test scenarios based on previous outcomes.

The stitching module 220 of the test automation system 102 may comprise suitable logic, and/or interfaces, that may be configured to stitch, at a runtime, a unique test script corresponding to each of the plurality of platforms, each of the plurality of operating systems, each of the plurality of end devices, each of the user profiles, and each of the plurality of versions of the streaming application using one or more components from the first set of test components and the second set of test components.

In one or more embodiments, the stitching module 220 operates at runtime to assemble test scripts, based on the execution plan which outlines the necessary parameters and conditions for the testing scenario, including platform specifications, operating system versions, and user profiles.

For each combination of platform, operating system, end device, user profile, and application version, the stitching module 220 generates a distinct test script by combining one or more components from the first set of test components and the second set of test components. This ensures that each specific scenario is tested thoroughly.

Consider an exemplary scenario where the functionality of searching a video within the streaming application needs to be tested. As discussed above, the workflow data is analyzed to categorize a first portion of the workflow as convergent pattern and the second portion as the divergent pattern, reflecting the variations in how search results are displayed or interacted with across different devices and user profiles.

The stitching module 220 combines test components that address the common patterns of initiating a search (convergent patterns) with those that test the specific ways search results are handled or presented on different operating systems (divergent patterns). This approach ensures that both general functionality and platform-specific nuances are thoroughly evaluated.

The result is a suite of distinct test scripts for each scenario-whether it be iOS, Android, Windows, or macOS-ensuring that the functionality not only works universally but also adapts perfectly to the differences of each platform and device. The comprehensive testing methodology helps guarantee that the application provides a seamless and reliable user experience across all intended user environments.

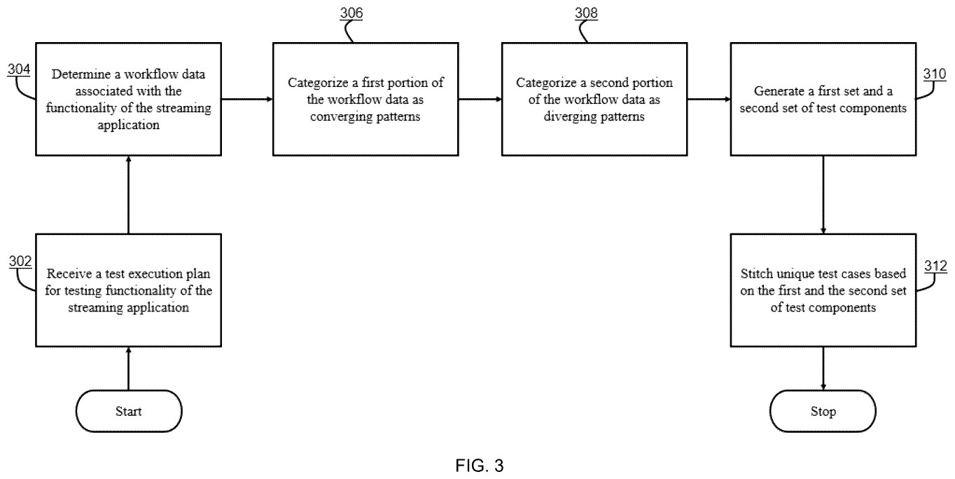

FIG. 3 is a flow chart 300 with a method for generating test cases for a streaming application, in accordance with an embodiment of the present disclosure.

At 302, the planning module 210 receives an execution plan for testing the functionality of the streaming application. This plan is based on a set of parameters including intent, environment, test data, and user profiles, which help define the scope and conditions for the test scenarios.

In one or more embodiments, the execution plan is defined based on one or more parameters such as, but not limited to, intents of a quality engineer (QE), environment of testing, test data, and profile of a user. The intents of QE for testing can be such as, for instance, what portion of the workflow to be tested, where to be tested, which platform to be tested, which suites to be tested.

In accordance with the one or more embodiments, a portion of the workflow to be tested may involve determining which parts of the application workflow data, spanning from a start point to an end point of user interactions with one or more elements of the streaming application require testing. The location of testing may specify where the tests should be executed, such as in a staging environment, a production-like environment, or a local development setup. The platform to be tested may involve identifying the platforms on which the tests should be executed, including, but not limited to, the plurality of operating systems, the plurality of end devices, and the plurality of browsers.

At 304, the machine-learning model 212 is employed to analyze the workflow data associated with the functionality of the streaming application with respect to each of the plurality of platforms, each of the plurality of operating systems, each of the plurality of end devices, each of the plurality of user profiles, and each of the plurality of versions of the streaming application. This workflow data encompasses a record of user interactions from the initiation to the completion of specific tasks within the application, capturing how users navigate through different features and functionalities, such as access, utilization, and engagement with various elements. The machine-learning module 212 determines the workflow data by leveraging a comprehensive set of libraries, including the user profile library, the intent library, the device library, and critically, the navigation.

The navigation engine plays a pivotal role in this process by mapping the user's journey from the start to the endpoint within the application. This journey involves a series of interactions with various UI elements, where the user performs input actions, such as clicks or touches, and receives output responses, such as visual feedback or state changes.

The initiation of the workflow begins when a user takes an initial action, such as opening the application or logging in, with specific details like device type, time, and user identity recorded. Subsequent user actions could include searching for content, browsing categories, selecting a stream, or adjusting settings, leading up to the completion of the workflow, marked by activities such as closing the application, completing a stream, or exiting a feature.

The navigation engine organizes and interprets these interactions, ensuring that the workflow data reflects the precise sequence of user actions and corresponding outputs across diverse environments. This mapping allows the system to accurately assess and generate the necessary test scripts tailored to specific devices and platforms, ensuring that all possible variations in user interaction, input, output, and element behavior are thoroughly covered.

At 306, the convergence module 214 categorizes a first portion of the workflow data that is consistent across the plurality of platforms, the plurality of operating systems, the plurality of end devices, and the plurality of versions of the streaming application, as converging patterns.

In one or more embodiments, the workflow data that is consistent refers to a record of user interactions and processes that are common from the initiation to the completion of a specific task with the streaming application. The workflow data captures how the user navigates through various features and functionalities in common patterns, including access, utilization, and engaging with different elements of the streaming application.

At 308, the divergence module 216 categorizes a second portion of the workflow data that varies across the plurality of platforms, the plurality of operating systems, the plurality of end devices, and the plurality of versions of the streaming application, as divergent patterns.

In one or more embodiments, the variations in the workflow data refers to a record of user interactions and processes that are different from the initiation to the completion of a specific task with the streaming application. The workflow data captures how the user navigates through various features and functionalities in varying patterns, including access, utilization, and engaging with different elements of the streaming application.

At 310, the test components generation module 218 is used to generate the first set of test components corresponding to the converging patterns and the second set of test components corresponding to the diverging patterns. These components might be partial or complete sets of test instructions tailored to address the specific behaviors observed in those patterns.

In one or more embodiments, the first set of test components refer to individual pieces or units of tests used to assess various aspects of an application's functionality. They may include test scripts, test cases, or other testing artifacts. The first set of test components consists of test cases tailored to test the converging patterns in the workflow.

In one or more embodiments, the second set of test components refer to individual pieces or test units of tests used to assess various aspects of an application's functionality. They include test scripts, test cases, or other testing artifacts. The second set of test components consists of test cases tailored to test the divergent patterns in the workflow.

At 312, the stitching module 220 stitches a unique test script corresponding to each of the plurality of platforms, each of the plurality of operating systems, each of the plurality of end devices, each of the user profiles, and each of the plurality of versions of the streaming application using one or more test components from the first set of test components and the second set of test components based on the test execution plan, at runtime.

In one or more embodiments, the stitching module 220 operates at runtime to assemble test scripts, based on the execution plan. This is done at runtime, using both sets of test components based on the test execution plan. The result is a suite of tailored test scripts that are specifically crafted to perform thorough and effective testing of the streaming application under a variety of user conditions and technical environments.

The present disclosure is advantageous in a manner that it provides a method and system for generating test scripts that are adaptive and are agnostic to various platforms, various operating systems, various devices, various user profiles, and various versions of a streaming application. The method and system provides a robust framework for generating test scripts that are not only flexible and scalable but also capable of ensuring consistent quality and performance across diverse environments and user contexts. By implementing a dynamic pattern recognition system and real-time test component stitching, the disclosure eliminates the traditional challenge of maintaining separate test suites for each platform combination, thereby achieving true platform independence in testing workflows.

Another key advantage of this method and system is its ability to significantly reduce the amount of duplicated code repositories and the associated code footprint. By dynamically generating test case scripts that adaptively stitch together components addressing both convergent and divergent patterns, the system minimizes the need for extensive code replication across different applications and platform combinations. This streamlined approach leads to reduced engineering effort, simplified maintenance of test scripts, efficient resource utilization, and uniformity in testing across platforms. With fewer code repositories to manage, developers avoid the complexities and overhead associated with maintaining multiple sets of test scripts, enhancing code quality and streamlining the development and testing processes. The system's intelligent component reuse mechanism and automated pattern detection significantly reduce the testing infrastructure overhead while maintaining comprehensive test coverage.

Yet, another major benefit of this method and system is that it offers the distinct advantage of rapid adaptability to new technologies and changing user behaviors. By leveraging machine learning algorithms, the system can continuously learn from new data and immediately incorporate these insights into test scripts. This capability ensures that the test cases remain relevant and effective even as the streaming application evolves, whether through updates, new features, or changes in user interaction patterns. This proactive approach to testing not only maintains high standards of application performance and user experience but also reduces the time and cost associated with manual test updates, further accelerating the development cycle and enhancing product responsiveness to market demands. The system's self-learning capabilities and automated pattern recognition ensure that test coverage automatically expands to include new platform features and user interaction patterns without manual intervention.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of ordinary skills in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A computer-implemented method for generating test cases for a streaming application, the method comprising:
receiving, by a computer, a test execution plan for testing functionality of the streaming application based on a set of parameters comprising, intent, environment, test data, and profiles;
determining, by a computer, using a trained machine-learning model, a workflow data associated with the functionality of the streaming application with respect to each of a plurality of platforms, each of a plurality of operating systems, each of a plurality of end devices, each of a plurality of user profiles, and each of a plurality of versions of the streaming application, the workflow data being determined using at least one of a user profile library, an intent library, a device library, an input devices library, and a navigation library;
categorizing by a computer, a first portion of the workflow data that is consistent across the plurality of platforms, the plurality of operating systems, the plurality of end devices, and the plurality of versions of the streaming application, as converging patterns;
categorizing by a computer, a second portion of the workflow data that varies across the plurality of platforms, the plurality of operating systems, the plurality of end devices, and the plurality of versions of the streaming application, as divergent patterns;
generating, by a computer, using a trained machine learning model, a first set of test components corresponding to the converging patterns and a second set of test components corresponding to the diverging patterns; and
stitching, by a computer, at runtime, a unique test case corresponding to each of the plurality of platforms, each of the plurality of operating systems, each of the plurality of end devices, each of the user profiles, and each of the plurality of versions of the streaming application using the first set of test components and the second set of test components based on the test execution plan.

2. The method of claim 1, wherein the trained machine-learning model is trained using historical data associated with previous test executions, comprising user interactions, platform configurations, and device-specific behaviors.

3. The method of claim 2, wherein the historical data further comprises feedback from prior test executions, including error rates, performance metrics, and success rates, which are used to optimize the machine-learning model.

4. The method of claim 1, wherein the trained machine-learning model is continuously updated based on real-time data collected from ongoing test executions to improve accuracy of test scripts.

5. The method of claim 1, wherein the training of the machine-learning model includes the use of one or more learning techniques, wherein the training data comprises multiple data types to enhance the model's ability to identify converging and diverging patterns.

6. The method of claim 1, wherein the navigation library comprises a set of predefined paths representing typical user journeys through the streaming application.

7. The method of claim 6, wherein the navigation library is dynamically updated based on real-time user behavior data.

8. The method of claim 1, wherein the user profile library contains data on user preferences, behaviors, and interaction histories.

9. The method of claim 1, wherein the device library contains specifications for a plurality of end devices, including screen sizes, input methods, processing power, information about device-specific limitations or capabilities and operating system versions.

10. The method of claim 1, wherein the navigation library is linked to one or more other libraries comprising a page object model (POM) library, a trigger library, and an assertion library.

11. A system for generating test cases for a streaming application, the system comprising:
a processor;
a memory communicatively coupled to the processor, the memory storing instructions that, when executed by the processor, cause the system to perform operations comprising:
receiving a test execution plan for testing a functionality of the streaming application based on a set of parameters comprising, intent, environment, test data, and profiles;
determining, using a trained machine-learning model, a workflow data associated with the functionality of the streaming application with respect to each of a plurality of platforms, each of a plurality of operating systems, each of a plurality of end devices, and each of a plurality of versions of the streaming application, the workflow data being determined using at least one of a user profile library, an intent library, a device library, an input devices library, and a navigation library;
categorizing a first portion of the workflow data that is consistent across the plurality of platforms, the plurality of operating systems, the plurality of end devices, and the plurality of versions of the streaming application, as converging patterns;
categorizing a second portion of the workflow data that varies across the plurality of platforms, the plurality of operating systems, the plurality of end devices, and the plurality of versions of the streaming application, as divergent patterns;
generating, using a trained machine learning model, a first set of test components corresponding to the converging patterns and a second set of test components corresponding to the diverging patterns; and
stitching, at runtime, a unique test case corresponding to each of the plurality of platforms, each of the plurality of operating systems, each of the plurality of end devices, each of the user profiles, and each of the plurality of versions of the streaming application using the first set of test components and the second set of test components based on the test execution plan.

12. The system of claim 11, wherein the trained machine-learning model is trained using historical data associated with previous test executions, including user interactions, platform configurations, and device-specific behaviors.

13. The system of claim 11, wherein the trained machine-learning model is continuously updated based on real-time data collected from ongoing test executions to improve accuracy of test scripts.

14. The system of claim 11, wherein the navigation library comprises a set of predefined paths representing typical user journeys through the streaming application.

15. The system of claim 11, wherein the navigation library is dynamically updated based on real-time user behavior data.

16. The system of claim 11, wherein the user profile library contains data on user preferences, behaviors, and interaction histories.

17. The system of claim 11, wherein the device library contains specifications for a plurality of end devices, including screen sizes, input methods, processing power, information about device-specific limitations or capabilities and operating system versions.

18. The system of claim 11, wherein the navigation library is linked to one or more other libraries comprising a page object model (POM) library, a trigger library, and an assertion library.
